(19) United States
(12) Patent Application Publication
(10) Pub. No.: US 2024/0404754 A1
(43) Pub. Date: Dec. 5, 2024

(54) DIELECTRIC CERAMIC COMPOSITION AND MULTILAYER CERAMIC ELECTRONIC DEVICE

(71) Applicant: TAIYO YUDEN CO., LTD., Tokyo (JP)

(72) Inventors: Yamato SASAKI, Tokyo (JP); Mika NISHIZAWA, Tokyo (JP)

(73) Assignee: TAIYO YUDEN CO., LTD., Tokyo (JP)

(21) Appl. No.: 18/679,359

(22) Filed: May 30, 2024

(30) Foreign Application Priority Data
Jun. 2, 2023 (JP) 2023-091847

(51) Int. Cl. H01G 4/12; C04B 35/468; H01G 4/30

(52) U.S. Cl. CPC H01G 4/1227; C04B 35/4682; H01G 4/30

(57) ABSTRACT

A dielectric ceramic composition includes a first crystal grain that has a perovskite structure expressed by a general formula of BaTiO₃, and has a core portion and a shell portion surrounding the core portion and including dysprosium, and a second crystal grain in which an elemental ratio of barium to titanium is 0.70 or less and a main component is barium titanate composite oxide. An elemental ratio of barium to titanium of the dielectric ceramic composition is 0.90 or more and 0.98 or less.

### FIELD

A certain aspect of the present disclosure relates to a dielectric ceramic composition and a multilayer ceramic electronic device.

### BACKGROUND

Multilayer ceramic electronic devices such as multilayer ceramic capacitors are used in high frequency communication systems, typified by mobile phones (see, for example, Patent Document 1 and Patent Document 2).

### PRIOR ART

### Patent Document

Document 1: Japanese Patent Application Publication No. 2018-137286
Document 2: Japanese Patent Application Publication No. 2018-139261

### SUMMARY OF THE INVENTION

In recent years, with the advancement of cloud computing and IoT, data centers are now able to communicate data at higher capacity and higher speeds. In order to cope with the increase in capacity and speed of communications, all electronic devices, including semiconductor devices, have become smaller and more densely surface-mounted. Because electronic devices such as semiconductors that serve as heat sources are housed in small circuit boards that are densely arranged, the temperature around the devices increases. In such a state, even the multilayer ceramic electronic devices, which are supposed to generate little heat, end up rising in temperature due to radiant heat and heat transfer from the semiconductor. Since the electrostatic capacity of multilayer ceramic electronic devices changes depending on temperature, there is a need for stable electrostatic capacity even at high temperatures.

In addition, in recent years, electrostatic capacity under conditions in which multilayer ceramic electronic devices are actually used, that is, electrostatic capacity (effective capacity) under application of Dc Bias, has become required. Although many attempts have been made to develop high electrostatic capacity under application of Dc Bias at room temperature, there are few reports on development of high electrostatic capacity at high temperature and under application of Dc Bias.

The present invention has been made in view of the above problems, and provides a dielectric ceramic composition and a multilayer ceramic electronic device that can achieve high dielectric constant and high reliability under high temperature and Dc bias application conditions.

According to an aspect of the embodiments, there is provided a dielectric ceramic composition including: a first crystal grain that has a perovskite structure expressed by a general formula of BaTiO₃, and has a core portion and a shell portion surrounding the core portion and including dysprosium; and a second crystal grain in which an elemental ratio of barium to titanium is 0.70 or less and a main component is barium titanate composite oxide, wherein an elemental ratio of barium to titanium of the dielectric ceramic composition is 0.90 or more and 0.98 or less.

In the dielectric ceramic composition, The first crystal grain may include a donor element; and a concentration of the donor element at a grain boundary or a grain boundary triple point of the first crystal grain may be larger than that in the first crystal grain.

In the dielectric ceramic composition, the donor element may be at least one of vanadium and molybdenum.

In the dielectric ceramic composition, the second crystal grain may be at least one selected from a group of BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, Ba₄Ti₁₄O₂₇, or Ba₆Ti₁₇O₄₀.

In the dielectric ceramic composition, in the first crystal grain, a concentration of dysprosium of the shell portion may be higher than that of the core portion.

In the dielectric ceramic composition, the first crystal grain may include an acceptor element.

In the dielectric ceramic composition, the acceptor element may be at least one of manganese or magnesium.

According to another aspect of the embodiments, there is provided a dielectric ceramic composition including: barium titanate as a main component, wherein an elemental ratio of barium to titanium is 0.90 or more and 0.98 or less, wherein the dielectric ceramic composition contains 0.5 mol or more and 3.0 mol or less of dysprosium per 100 mol of titanium, contains 0.05 mol or more and 0.5 mol or less of a donor element per 100 mol of titanium, contains 0.05 mol or more and 3.0 mol or less of an acceptor element per 100 mol of titanium, and contains 0.5 mol or more and 3.0 mol or less of silicon per 100 mol of titanium.

In the dielectric ceramic composition, the donor element may be at least one of vanadium or molybdenum.

In the dielectric ceramic composition, the acceptor element may be at least one of manganese or magnesium.

According to another aspect of the embodiments, there is provided a multilayer ceramic electronic device including: a dielectric ceramic composition as mentioned above.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a dielectric ceramic composition of a first embodiment;

FIG. 2 illustrates a unit lattice;

FIG. 3 illustrates a confirming method of a core-shell structure;

FIG. 4 is a partial cross-sectional perspective view of a multilayer ceramic capacitor;

FIG. 5 is a cross-sectional view taken along line A-A in FIG. 4;

FIG. 6 is a cross-sectional view taken along line B-B in FIG. 4;

FIG. 7 illustrates a flow of a manufacturing method of a multilayer ceramic capacitor;

FIG. 8A and FIG. 8B illustrate a forming process of an internal electrode;

FIG. 9 illustrates a crimping process; and

FIG. 10 illustrates a case where a side margin portion is attached.

### DETAILED DESCRIPTION

Hereinafter, an exemplary embodiment will be described with reference to the accompanying drawings.

### First Embodiment

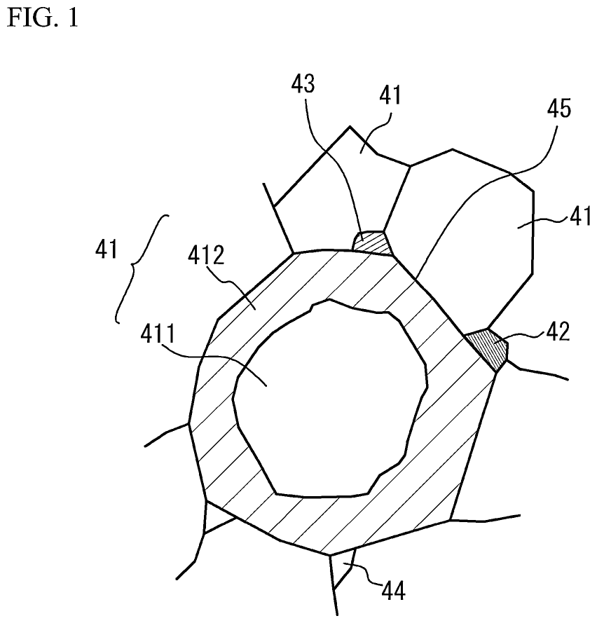

The dielectric ceramic composition according to a first embodiment is a ceramic polycrystalline body containing crystal grains having a perovskite structure represented by the general formula ABO₃, as illustrated in FIG. 1. At least one of these ceramic polycrystalline is a first crystal grain 41 having a core-shell structure, and at least one is a second crystal grain 42 in which the elemental ratio of barium to titanium is 0.70 or less.

The first crystal grain 41 includes a substantially spherical core portion 411 and a shell portion 412 that surrounds and covers the core portion 411. The core portion 411 is a crystalline portion in which the additive compound is not dissolved in solid solution or the amount of the additive compound in solid solution is small. The shell portion 412 is a crystalline portion in which the additive compound is solid-solved and has a higher concentration of the additive compound than the concentration of the additive compound in the core portion 411. In this embodiment, the shell portion 412 contains dysprosium. For example, the elemental concentration of dysprosium in the shell portion 412 is higher than the elemental concentration of dysprosium in the core portion 411.

By including the first crystal grains 41 and the second crystal grains 42, the dielectric ceramic composition according to the present embodiment can achieve high dielectric constant and high reliability under high temperature and Dc bias application conditions.

For example, when observing a cross section of the dielectric ceramic composition in a field of view where 400 or more of the first crystal grains 41 and the second crystal grains 42 are observed in total, the area ratio of the first crystal grains 41 is 50% or more and 99.95% or less, and the area ratio of the second crystal grains 42 is 0.05% or more and 50% or less.

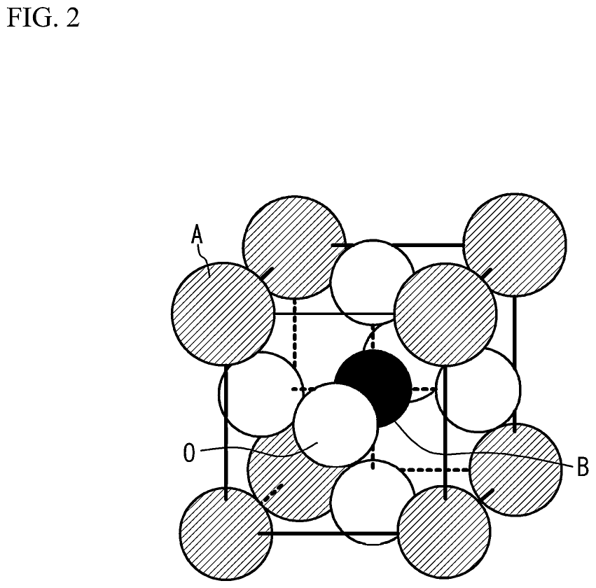

Crystal grains having a perovskite structure, which are the main components of the first crystal grains 41, have a unit cell as illustrated in FIG. 2. This unit cell has an A site located at the apex of the lattice, an O site located at the face center of the lattice, and a B site located within an octahedron with the O site as the apex. In the perovskite structure, alkaline earth metals that can take divalent cations such as barium (Ba), strontium (Sr), or calcium (Ca) are located at the A site, and hafnium (Hf) or zirconium (Zr), or titanium (Ti) that can take tetravalent cations are located at the B site.

The perovskite structure also allows a composition formula that deviates from the stoichiometric composition. That is, the ratio of the A-site element to the B-site element does not necessarily have to be 1:1, and defects may be generated within a range where the perovskite structure can be maintained. Furthermore, defects may also be generated regarding oxygen. For example, when the composition formula is A_{α}BO_{3-β}, compositions in the ranges of 0.90≤α≤0.98 and 0≤β≤0.20 are allowed.

In the dielectric ceramic composition according to the present embodiment, if the Ba/Ti element ratio, which represents the barium content relative to the titanium content, is too low, there is a risk that the insulation properties will decrease. Therefore, it is preferable to set a lower limit on the Ba/Ti element ratio. On the other hand, if the Ba/Ti element ratio is too high, tan δ may become high. Therefore, it is preferable to set an upper limit on the Ba/Ti element ratio. In this embodiment, the Ba/Ti element ratio is preferably 0.90 or more and 0.98 or less. For example, the Ba/Ti element ratio can be adjusted by adding an additive containing titanium to barium titanate. Preferred examples of the above-mentioned additives containing titanium include titanium oxide, titanium hydroxide (Ti(OH)₄), titanium chloride (TiCl₄), titanium carbide (TiC), or titanium sulfide (TiS₂) can also be used.

Note that if the content of dysprosium in the dielectric ceramic composition is low, there is a possibility that the first crystal grains 41 will not have a core-shell structure. Furthermore, if the content of dysprosium is low, tan δ may become high. Therefore, it is preferable to set a lower limit on the dysprosium content relative to the titanium content. On the other hand, if the content of dysprosium is large, there is a possibility that dysprosium will be substituted as a solid solution at the A site of the perovskite structure and act as a donor. Therefore, it is preferable to set an upper limit on the content of dysprosium relative to the content of titanium. In this embodiment, it is preferable that dysprosium is contained in an amount of 0.5 mol or more and 3.0 mol or less per 100 mol of titanium. When expressed as a Dy/Ti element ratio, it is preferably 0.5 at % or more and 3.0 at % or less.

For example, the generation of oxygen defects in the first crystal grains 41 may cause a decrease in resistivity or exhibit ionic conductivity, resulting in a decrease in electrical life when used as a multilayer ceramic capacitor, and dielectric loss may become too large to be used practically. Therefore, it is preferable that the first crystal grains 41 having a perovskite structure contain a donor element, if necessary. When the first crystal grains 41 contain a donor element, the generation of oxygen defects is suppressed, and it is possible to improve resistivity, increase electrical life, and reduce dielectric loss with respect to electrostatic capacity. As a donor element, for example, at least one of vanadium or molybdenum can be used.

As illustrated in FIG. 1, a donor element segregation 43 may be present at grain boundaries 45 or grain boundary triple points of the first crystal grains 41. When the segregation 43 is present, the concentration of the donor element in the segregation 43 is preferably higher than the concentration of the donor element in the first crystal grains 41 adjacent to the segregation 43. The segregation 43 becomes an obstacle when oxide ion defects migrate to the cathode. Therefore, the presence of the segregation 43 improves reliability. In addition, the dielectric ceramic composition may include voids 44 and the like.

In the dielectric ceramic composition, if the content of the donor element is low, the oxide ion vacancy concentration may become high. Therefore, it is preferable to set a lower limit on the content of the donor element relative to the content of titanium. On the other hand, if the content of the donor element is high, there is a possibility that the insulation property will be reduced. Therefore, it is preferable to set an upper limit on the content of the donor element relative to the content of titanium. In this embodiment, it is preferable that the donor element is contained in an amount of 0.05 mol or more, and preferably 0.5 mol or less, per 100 mol of titanium. When expressed as an element ratio such as V/Ti or Mo/Ti, it is preferably 0.05 at % or more, and preferably 0.5 at % or less. In addition, when adding multiple types of donor elements, the content of the donor elements means the total amount of the multiple types of donor elements.

It is preferable that the first crystal grains 41 contain an acceptor element. For example, at least one of manganese and magnesium can be used as the acceptor element. Since the first crystal grains 41 contain the acceptor element, reduction of the dielectric ceramic composition can be suppressed.

In the dielectric ceramic composition, if the content of the acceptor element is low, tan δ may increase due to reduction. Therefore, it is preferable to set a lower limit on the content of the acceptor element relative to the content of titanium. On the other hand, if the content of the acceptor element is large, the effective dielectric constant may decrease. Therefore, it is preferable to set an upper limit on the content of the acceptor element relative to the content of titanium. In this embodiment, the acceptor element is preferably contained in an amount of 0.05 mol or more, and preferably 3.0 mol or less, per 100 mol of titanium. When expressed in terms of element ratios such as Mn/Ti and Mg/Ti, it is preferably 0.05 at % or more, and preferably 3.0 at % or less. In addition, when adding multiple types of acceptor elements, the content of the acceptor elements means the total amount of the multiple types of acceptor elements.

The dielectric ceramic composition preferably contains silicon. When the dielectric ceramic composition contains silicon, the dielectric ceramic composition becomes dense and has good effective dielectric constant and reliability. The dielectric ceramic composition preferably contains boron or the like in addition to silicon.

In the dielectric ceramic composition, if the silicon content is low, there is a risk that the life span will be shortened. Therefore, it is preferable to set a lower limit on the silicon content relative to the titanium content. On the other hand, if the silicon content is high, the effective dielectric constant may decrease. Therefore, it is preferable to set an upper limit on the silicon content relative to the titanium content. In this embodiment, silicon is preferably contained in an amount of 0.5 mol or more, and preferably 3.0 mol or less, per 100 mol of titanium. When expressed in terms of Si/Ti element ratio, it is preferably 0.5 at % or more, and preferably 3.0 at % or less.

By adding manganese, silicon, or boron to the dielectric ceramic composition, the firing temperature can be lowered. If it becomes possible to fire at low temperatures, the power required for firing can be significantly reduced, contributing to the SDGs.

Here, the presence of the first crystal grains 41 having a core-shell structure in the dielectric ceramic composition can be confirmed by the following procedure.

First, a sample for transmission electron microscopy (TEM) observation is cut out from the dielectric ceramic composition to be confirmed. This cutting out can be performed using a focused ion beam (FIB) device or the like.

Next, the cut sample for TEM observation is observed with a TEM equipped with an energy dispersive X-ray spectrometer (EDS) or a wavelength dispersive X-ray spectrometer (WDS) to determine the crystal grains to be measured. At the same time, the outer circumferential shape of the grain is specified.

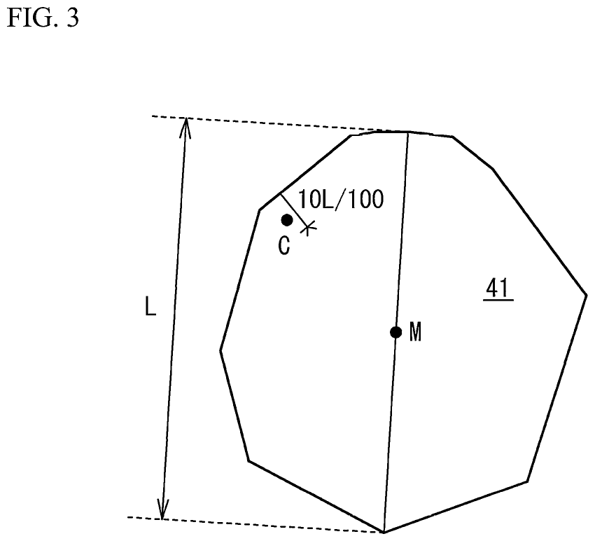

Next, as illustrated in FIG. 3, among the line segments connecting arbitrary two points located on the outer periphery of the crystal grain to be measured (the first crystal grain 41), the one with the maximum length is determined, and the length L of the line segment is measured. Then, this length L is taken as the diameter of the crystal grain to be measured. Furthermore, the midpoint M of the line segment is determined from the obtained length of the line segment.

A composition analysis using EDS or WDS on any point C on the outer periphery within a length range of 10% of the diameter of the crystal grain, that is, 10 L/100, from both ends of the above line segment is performed. And the element abundance ratio between the element and the titanium element is calculated. In compositional analysis, for example in EDS measurement, it is simply identified by the K-line intensity of titanium relative to the K-line or L-line of barium, the L-line of gadolinium, the K-line of manganese, and the K-line of magnesium. More specifically, from these intensities, a correction (ZAF correction) is performed that takes into account the atomic number effect, absorption effect, and fluorescence excitation effect, and the ratio of each to the elemental content of titanium is calculated. The calculated value is determined as a ratio of each element to titanium in the shell portion 412. Furthermore, compositional analysis is similarly performed for the midpoint M of the above line segment to calculate the ratio, and this is taken as the ratio of each element to titanium in the core portion 411.

Next, the ratio of each element to titanium in the shell portion 412 and the ratio of each element to titanium in the core portion 411 are compared, and when the ratio of the shell portion 412 is higher than that of the core portion 411, it is determined that the crystal grains 41 have a core-shell structure.

The second crystal grains 42 include at least one selected from BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, Ba₄Ti₁₄O₂₇, or Ba₆Ti₁₇O₄₀. In the second crystal grains 42, the element ratio of barium to titanium is preferably 0.16 or more.

As is clear from its compositional formula, the second crystal grains 42 are barium titanate composite oxides with a smaller amount of barium than barium titanate. The second crystal grains 42 are crystal grains that are produced as a subsidiary when an additive containing titanium as a main component is used as an additive. The first crystal grains 41 are obtained by intentionally precipitating the second crystal grains 42. For example, in a multilayer ceramic capacitor for which high mass productivity is required, the range of change in electrostatic capacity due to a change in firing temperature. It is possible to suppress this and obtain high mass productivity.

A more preferable example of the second crystal grains 42 is Ba₄Ti₁₁O₂₆, which is monoclinic and has a space group C2/m, and has lattice constants a=15.160 Å, b=3.893 Å, and c=9.093 Å, and β=98.6°. This is because the barium titanate composite oxide has a ratio of barium to titanium that is relatively close to 1, and can be easily precipitated intentionally without using a large amount of additives whose main component is titanium. The barium titanate composite oxide is described, for example, in the non-patent literature Acta Cryst. (1979). B35, 1590-1593.

As a more preferable example of the second crystal grains 42, it is desirable that manganese is solid-solved in Ba₄Ti₁₁O₂₆ and occupies the defect sites thereof, or that some titanium is replaced by manganese. As is clear from the above-mentioned non-patent literature, Ba₄Ti₁₁O₂₆ has a crystal structure in which some titanium sites have defects. Therefore, titanium tends to change from a tetravalent cation to a trivalent cation at the defect location, and as a result, the resistivity tends to decrease. In order to supplement this, it is effective to include manganese in solid solution.

Here, it can be confirmed that the dielectric ceramic composition contains the second crystal grains 42 by the following procedure.

First, the diffraction line profile of the surface of the dielectric ceramic composition to be confirmed or the powder obtained by crushing the dielectric ceramic composition is measured using an X-ray diffractometer (XRD) using Cu-Kα rays. The pulverizing means for obtaining the powder is not particularly limited, and a hand mill (mortar/pestle) or the like can be used. In addition, when measuring the diffraction profile of the ceramics that make up a multilayer ceramic capacitor, it is necessary to remove the electrodes and coatings formed on the surface of the element, as well as parts other than the dielectric layer of the multilayer ceramic capacitor. Thereby, the surface of the body porcelain composition is exposed. This exposure method is not particularly limited, and a method of cutting or polishing the element can be adopted. In addition, when measuring the diffraction profile of the powder of the dielectric ceramic composition that makes up the multilayer ceramic capacitor, the electrodes and coatings formed on the element, as well as parts other than the dielectric layer of the multilayer ceramic capacitor, are removed. It is more preferable to crush the mixture after the removing.

Next, in the obtained diffraction profile, the percentage of the strongest diffraction line intensity derived from other structures with respect to the strongest diffraction line intensity derived from the perovskite structure is calculated. If this ratio is 10% or less, it is determined that the dielectric ceramic composition to be confirmed is composed of the first crystal grains 41 having a perovskite structure. In addition, when the surface of the dielectric ceramic composition of a multilayer ceramic capacitor is exposed using the above method, or when XRD measurement is performed on pulverized powder, peaks of the materials constituting the electrodes and coatings may be also detected. Therefore, the above-mentioned ratio of diffraction line intensity is calculated after excluding these peaks.

Next, we will identify the crystal phase by focusing on peaks other than the diffraction line intensity derived from the perovskite structure. It is preferable to identify the crystal phase by searching a PDF (Powder Diffraction File) published by ICDD (International Center for Diffraction Data; Pennsylvania, USA) and searching to see if it contains the second crystal grains 42. Regarding Ba₄Ti₁₁O₂₆ as a preferred example, its production can be evaluated by identifying it with reference to PDF-01-083-1459.

Next, it is determined by the following method that the second crystal grains 42 are made of a barium titanate-based composite oxide in which the elemental ratio of barium to titanium is 0.70 or less.

First, the surface of the dielectric ceramic composition is exposed. This exposure method is not particularly limited, and a method of cutting or polishing the element can be adopted. At this time, in order to fully observe the internal ceramic structure, it is preferable to finally obtain a smoothness that can be judged as a mirror surface by using a diamond paste or the like with a thickness of 2 μm or less.

Next, the composition of the second crystal grains 42 is identified by an energy dispersive X-ray spectrometer (EDS) or an X-ray spectrometer (WDS: Wavelength Dispersive X-ray Spectrometry) attached to a scanning electron microscope (SEM) or a transmission electron microscope (TEM), an electron probe micro analyzer (EPMA), a laser irradiation inductively coupled plasma mass spectrometry (LA-ICP-MS), or the like.

For example, in EDS measurement, specifying is performed by the K-line intensity of titanium relative to the K-line or L-line of barium or the K-line of manganese. More specifically, from these intensities, a correction (ZAF correction) is performed that takes into account the atomic number effect, absorption effect, and fluorescence excitation effect, and the ratio of each to the elemental content of titanium is calculated, and the ratio of each element is calculated.

When performing EDS measurements, especially when using barium's La ray and titanium's Kα ray, their energy peaks are close to each other, and it may be difficult to adequately compare the element contents. For this reason, it is desirable that the Lβ2 line and LIIIab line of barium be obtained with sufficient intensity without peak overlap during measurement. Specifically, it is desirable that the intensity at the peak is 10,000 counts or more. At this time, the intensity of the characteristic X-rays from barium can be determined and the element content can be calculated, so even if the La rays of barium and the Kα rays of Ti overlap, the intensity of the Kα rays of titanium can be determined, and the element content can be evaluated with high accuracy.

When the elemental ratio of barium to titanium obtained by the above method is 0.70 or less, the crystal grain is determined to be the second crystal grain 42. That is, it is determined that it is one of the above-mentioned barium titanate composite oxides based on the fact that the elemental ratio of barium to titanium is small compared to the first crystal grains 41 made of barium titanate existing in the surroundings. At this time, if a SEM is used for the observation, the second crystal grains 42 are characterized by having relatively low brightness and being observed darkly compared to the first crystal grains 41, in observation using a back scattered electron image (BSE image). Moreover, as a more suitable judgment, it is desirable that the second crystal grains 42 be identified by evaluating the diffraction profile by XRD.

Next, in more detail, the part determined to be the second crystal grain 42 is cut out as a sample for transmission electron microscopy (TEM) observation, it is determined whether to confirm as BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀ by compering a diffraction image obtained using selected area diffraction method with data known literature. Note that this cut out can be performed using an FIB device or the like.

The solid solution of manganese in the second crystal grains 42 can be confirmed by the intensity of the titanium K line relative to the Mn K line by EDS, WDS, or EPMA. More specifically, from these intensities, ZAF correction is performed to calculate the ratio w of the elemental content of manganese to the elemental content of titanium. At this time, it is desirable that the range is 0.02≤w≤0.10, more preferably 0.02≤w≤0.05. At this time, for example, manganese becomes a solid solution in the defect position of the Ti site in Ba₄Ti₁₁O₂₆, and a decrease in resistivity of the dielectric ceramic composition can be suppressed.

### Second Embodiment

In a second embodiment, a multilayer ceramic capacitor 100 using the dielectric ceramic composition of the first embodiment will be described.

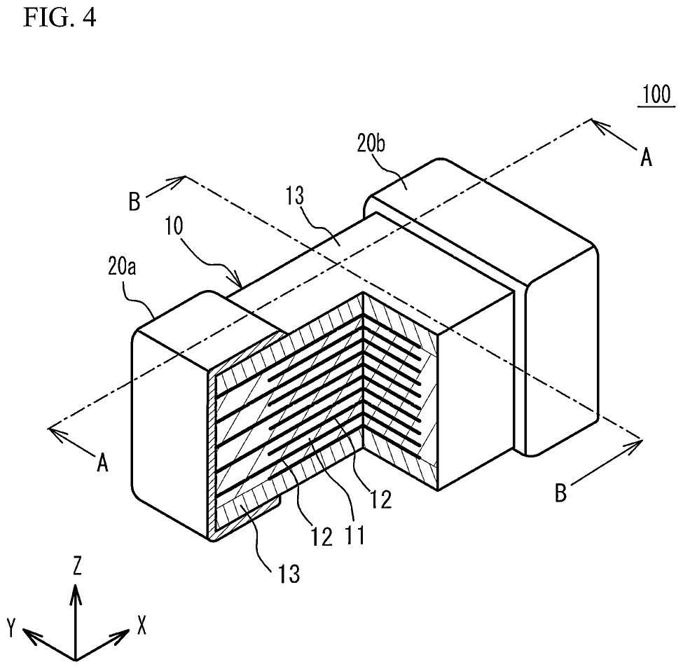

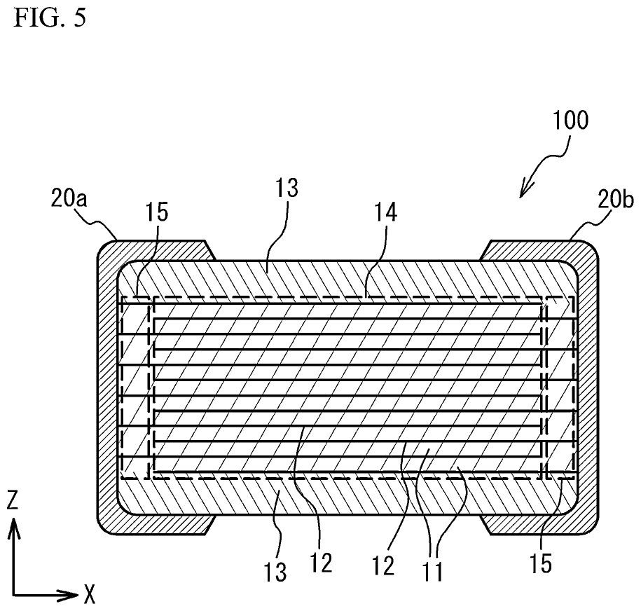

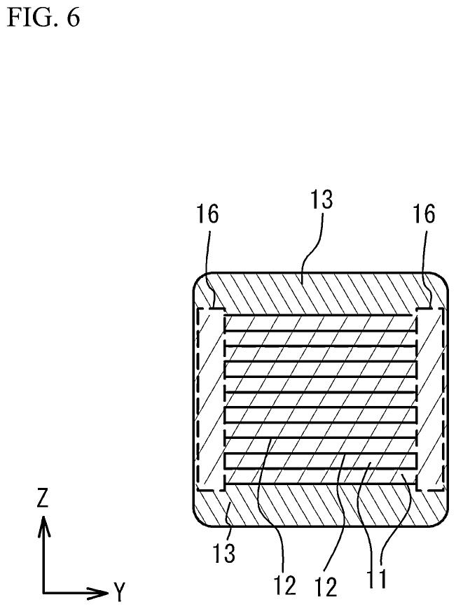

FIG. 4 illustrates a perspective view of the multilayer ceramic capacitor 100, in which a cross section of a part of the multilayer ceramic capacitor 100 is illustrated. FIG. 6 is a cross-sectional view taken along line A-A in FIG. 4. FIG. 6 is a cross-sectional view taken along line B-B in FIG. 4. As illustrated in FIG. 4 to FIG. 6, the multilayer ceramic capacitor 100 includes a multilayer chip 10 having a rectangular parallelepiped shape, and external electrodes 20a and 20b that are respectively provided on two end faces of the multilayer chip 10 opposite to each other. Among four faces other than the two end faces of the multilayer chip 10, two faces other than the top face and the bottom face in the stack direction are referred to as side faces. Each of the external electrodes 20a and 20b extends to the top face and the bottom face in the stack direction and the two side faces of the multilayer chip 10. However, the external electrodes 20a and 20b are spaced from each other.

The multilayer chip 10 has a structure in which dielectric layers 11 containing the dielectric ceramic composition and internal electrode layers 12 mainly composed of a base metal are alternately stacked. In other words, the multilayer chip 10 includes the internal electrode layers 12 facing each other and the dielectric layers 11 sandwiched between the internal electrode layers 12. The edges in the direction in which each internal electrode layer 12 extends are alternately exposed at a first end face provided with the external electrode 20a of the multilayer chip 10 and a second end face provided with the external electrode 20b. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The internal electrode layer 12 is mainly composed of a base metal such as nickel (Ni), copper (Cu), or tin (Sn). The internal electrode layer 12 may be composed of a noble metal such as platinum (Pt), palladium (Pd), silver (Ag), or gold (Au) or alloy including one or more of them.

As illustrated in FIG. 4, the section where the internal electrode layer 12 connected to the external electrode 20a faces the internal electrode layer 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin section 15. The section where the internal electrode layers 12 connected to the external electrode 20b face each other with no internal electrode layer 12 connected to the external electrode 20a interposed therebetween is another end margin section 15. That is, the end margin section 15 is a section where the internal electrode layers 12 connected to one of the external electrodes face each other with no internal electrode layer 12 connected to the other of the external electrodes interposed therebetween. The end margin section 15 is a section where no capacity is generated.

As illustrated in FIG. 6, in the multilayer chip 10, a section from one of the two side faces of the multilayer chip 10 to lateral side edges of the internal electrode layers 12 is referred to as a side margin section 16. That is, each of the side margin sections 16 is a section that covers the lateral side edges, extending toward one of the side faces of the multilayer structure, of the stacked internal electrode layers 12. The side margin section 16 is a section where no capacity is generated.

In the multilayer ceramic capacitor 100 according to the present embodiment, at least a portion of the dielectric layer 11 in the capacity section 14 includes the first crystal grains 41 illustrated in FIG. 1 and also includes the second crystal grains 42 illustrated in FIG. 1. Thereby, the rate of change in capacity due to changes in firing temperature can be suppressed and high mass productivity can be achieved.

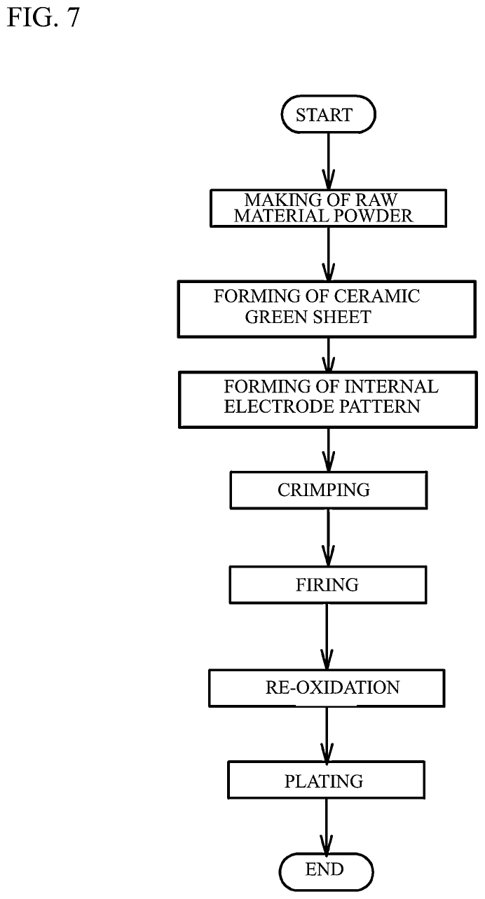

Next, a description will be given of a manufacturing method of the multilayer ceramic capacitors 100. FIG. 7 illustrates a manufacturing method of the multilayer ceramic capacitor 100.

(Making process of raw material powder) The dielectric ceramic composition for forming the dielectric layer 11 is prepared. Generally, an A site element and a B site element are included in the dielectric layer 11 in a sintered phase of grains of ABO₃. For example, BaTiO₃ is tetragonal compound having a perovskite structure and has a high dielectric constant. Generally, BaTiO₃ is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

An additive compound may be added to the resulting ceramic powder, in accordance with purposes. As an example, the additive of the dielectric ceramic composition of the first embodiment is used. If necessary, an oxide or a glass containing Zr (zirconium), V (vanadium), Cr (chromium), Co (cobalt), Ni (nickel), Li (lithium), B (boron), Na (sodium), K (potassium) may also be used. If necessary, an oxide of a rare earth element other than dysprosium such as Gd (gadolinium), Sc (scandium), Y (yttrium), La (lanthanum), Ce (cerium), Pr (praseodymium), Nd (neodymium), Pm (promethium), Sm (samarium), Tb (terbium), Ho (holmium), Er (erbium), Tm (thulium), Y (ytterbium), and Lu (lutetium) may be added.

For example, a compound containing an additive compound is wet-mixed with barium titanate powder, dried and pulverized to prepare a ceramic material in which barium titanate powder and the additive compound are mixed. For example, the ceramic material obtained as described above may be pulverized to adjust the particle size, if necessary, or may be combined with a classification process to adjust the particle size. Specifically, the particles are stirred for 10 to 100 hours with ceramic materials and beads with a diameter of 0.1 mm to 3 mm made of yttrium stabilized zirconia (YSZ), alumina, silicon nitride or the like. Thus, the diameter of the particles can be adjusted. Through the above process, a dielectric ceramic composition is obtained.

(Forming of dielectric green sheet) Next, a binder such as polyvinyl butyral (PVB) resin, an organic solvent such as ethanol or toluene, and a plasticizer are added to the resulting dielectric material and wet-blended. With use of the resulting slurry, a dielectric green sheet 51 is painted on a base material by, for example, a die coater method or a doctor blade method, and then dried. The base material is, for example, PET (polyethylene terephthalate) film. Figures of forming of the dielectric green sheet is omitted.

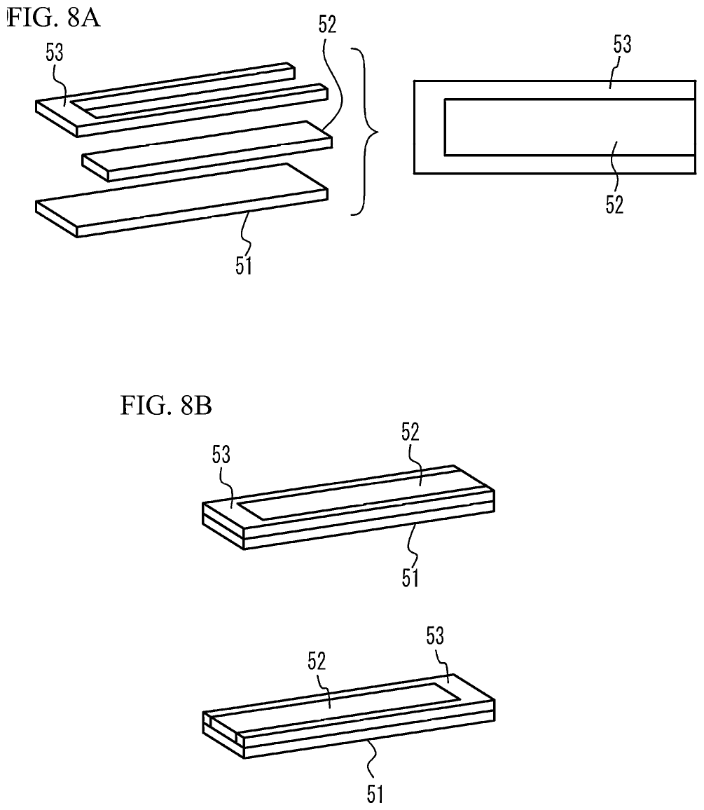

(Forming of internal electrode) Next, as illustrated in FIG. 8A, a metal conductive paste containing an organic binder for forming internal electrodes is printed on the surface of the ceramic green sheet 51 by screen printing, gravure printing, or the like. Internal electrode patterns 52 are arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium titanate having an average particle size of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 8A, on the ceramic green sheet 51, a dielectric pattern 53 is arranged by printing a dielectric pattern paste in the peripheral area where the internal electrode pattern 52 is not printed, and a gap with the internal electrode pattern 52 is filled. The ceramic green sheet 51 on which the internal electrode pattern 52 and the dielectric pattern 53 are printed is referred to as a stack unit.

Thereafter, as illustrated in FIG. 8B, the internal electrode layers 12 and the dielectric layers 11 are arranged alternately, and the internal electrode layers 12 have edges on both longitudinal end surfaces of the dielectric layers 11. The stack units are stacked so that they are alternately exposed and drawn out alternately to a pair of the external electrodes 20a and 20b having different polarities. For example, the number of stacked layers of the internal electrode pattern 52 is set to 100 to 1000 layers.

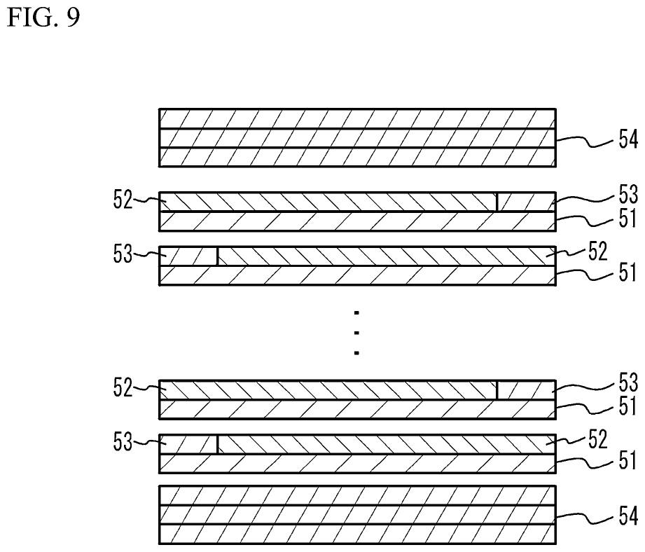

(Crimping Process) As illustrated in FIG. 9, a predetermined number (for example, 2 to 10 layers) of cover sheets 54 are stacked on top and bottom of the multilayer body in which the stack units are stacked and bonded by thermocompression. As an example of the ceramic material for the cover sheet 54, the dielectric ceramic composition described above can be used. Thereafter, the multilayer body is cut into a predetermined chip size (for example, 1.0 mm×0.5 mm).

(Firing process) After de-binding the ceramic multilayer body thus obtained in an N₂ atmosphere, air atmosphere or the like, a metal paste that will become the base layer of the external electrodes 20a and 20b is applied by a dip method, and the ceramic multilayer body is fired in a reductive atmosphere under an oxygen partial pressure of 10⁻¹² to 10⁻⁹ atm, 1100° C. to 1300° C. for 10 minutes to 2 hours. In this way, the multilayer ceramic capacitor 100 is obtained. Note that in the firing step, the temperature is rapidly raised. The temperature increase rate in the firing step is, for example, 6000° C./h. Thereby, the second crystal grains 42 do not become huge grains, and furthermore, the time required for firing can be substantially shortened, and higher mass productivity can be achieved.

(Re-oxidation treatment process) Thereafter, re-oxidation treatment may be performed at 600° C. to 1000° C. in an N₂ gas atmosphere.

(Plating process) Thereafter, a metal coating such as Cu, Ni, Sn and so on is performed on the base layer of the external electrodes 20a and 20b by plating. Through the above steps, the multilayer ceramic capacitor 100 is completed.

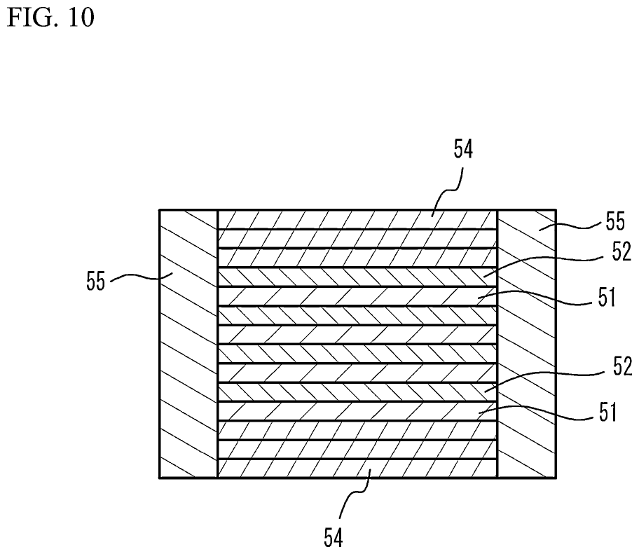

The side margin section may be attached or coated on the side surface of the ceramic multilayer body. Specifically, as illustrated in FIG. 10, the ceramic multilayer body is obtained by alternately stacking the ceramic green sheets 51 and the internal electrode patterns 52 having the same width as the ceramic green sheets 51. Next, a sheet formed of the dielectric pattern paste may be attached as a side margin section 55 to the side surface of the ceramic multilayer body.

According to the manufacturing method according to the present embodiment, the first crystal grains 41 illustrated in FIG. 1 are formed in at least a portion of the dielectric layer 11 of the capacity section 14, and the second crystal grains 42 are also formed. Therefore, high dielectric constant and high reliability can be achieved under high temperature and Dc bias application conditions.

In the embodiments, the multilayer ceramic capacitor is described as an example of ceramic electronic devices. However, the embodiments are not limited to the multilayer ceramic capacitor. For example, the embodiments may be applied to another electronic device such as varistor or thermistor.

### Example 1

Powders of TiO₂, Dy₂O₃, MoO₃, MnCO₃, and SiO₂ were added to BaTiO₃ powder. Specifically, TiO₂ was added to BaTiO₃ powder so that the Ba/Ti element ratio was 0.98. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. These were mixed with ethanol and toluene. A dispersant was added as appropriate to adjust the viscosity. A dielectric slurry was prepared by mixing in a ball mill using YSZ balls. This slurry was formed into a ceramic green sheet with a thickness of 2.5 μm using a die coater. After drying this sheet, Ni paste was printed as an internal electrode pattern. The printed sheets were stacked in 11 layers, cover sheets were stacked above and below the sheets, and the sheets were crimped and cut into small pieces. Ni paste was dipped into the end faces as terminal electrodes, and then degreased in N₂ gas. The degreased small piece was fired at 1280° C. for 2 hours in a N₂—H₂-H₂O mixed gas controlled to have an oxygen partial pressure that would not oxidize Ni, to produce a sintered multilayer ceramic capacitor.

The multilayer ceramic capacitor thus produced had a 1005 shape (1.0×0.5×0.5 mm³). At this point, a product with a size 10% or more larger than the 1005 size was determined to be an insufficiently densified product that had not been sintered in the sintering process. The thickness of the dielectric layer after sintering which reached the 1005 shape was 2.0 μm. This sintered multilayer ceramic capacitor was further subjected to re-oxidation treatment at 850° C. for 2 hours in a mixed gas of N₂ and several ppm of O₂.

### Example 2

TiO₂ was added to BaTiO₃ powder so that the Ba/Ti element ratio was 0.90, and Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 1

The Ba/Ti element ratio was set to 1.00. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 2

TiO₂ was added to BaTiO₃ powder so that the Ba/Ti element ratio was 0.80. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 3

TiO₂ was added to BaTiO₃ powder so that the Ba/Ti element ratio was 0.96. MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Example 3

TiO₂ was added to BaTiO₃ powder so that the Ba/Ti element ratio was 0.96. Dy₂O₃ was added so that the elemental ratio of dysprosium was 0.5 mol (0.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Example 4

TiO₂ was added to BaTiO₃ powder so that the Ba/Ti element ratio was 0.96. Dy₂O₃ was added so that the elemental ratio of dysprosium was 1.0 mol (1.0 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 4

TiO₂ was added to BaTiO₃ powder so that the Ba/Ti element ratio was 0.96. Dy₂O₃ was added so that the elemental ratio of dysprosium was 5.0 mol (5.0 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 5

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, V₂O₅ was added so that the elemental ratio of vanadium was 0.01 mol (0.01 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Example 5

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, V₂O₅ was added so that the elemental ratio of vanadium was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Example 6

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, V₂O₅ was added so that the elemental ratio of vanadium was 0.3 mol (0.3 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 6

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, V₂O₅ was added so that the elemental ratio of vanadium was 1.5 mol (1.5 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 7

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.01 mol (0.01 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Example 7

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### P (Example 8)

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.3 mol (0.3 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 8

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 1.5 mol (1.5 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Comparative Example 9

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.01 mol (0.01 at %) to 100 mol of titanium, and SiO₂ was added so that the elemental ratio of silicon was 1.0 mol (1.0 at %) to 100 mol of titanium. Other conditions were the same as in Example 1.

### Example 9

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.15 mol (0.15 at %) to 100 mol of titanium, and SiO₂ was added so that the elemental ratio of silicon was 1.0 mol (1.0 at %) to 100 mol of titanium. Other conditions were the same as in Example 1.

### Example 10

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 2.0 mol (2.0 at %) to 100 mol of titanium, and SiO₂ was added so that the elemental ratio of silicon was 1.0 mol (1.0 at %) to 100 mol of titanium. Other conditions were the same as in Example 1.

### Comparative Example 10

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 5.0 mol (5.0 at %) to 100 mol of titanium, and SiO₂ was added so that the elemental ratio of silicon was 1.0 mol (1.0 at %) to 100 mol of titanium. Other conditions were the same as in Example 1.

### Comparative Example 11

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MgO was added so that the elemental ratio of magnesium was 0.01 mol (0.01 at %) to 100 mol of titanium, and SiO₂ was added so that the elemental ratio of silicon was 1.0 mol (1.0 at %) to 100 mol of titanium. Other conditions were the same as in Example 1.

### Example 11

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MgO was added so that the elemental ratio of magnesium was 0.1 mol (0.1 at %) to 100 mol of titanium, and SiO₂ was added so that the elemental ratio of silicon was 1.0 mol (1.0 at %) to 100 mol of titanium. Other conditions were the same as in Example 1.

### Example 12

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MgO was added so that the elemental ratio of magnesium was 2.0 mol (2.0 at %) to 100 mol of titanium, and SiO₂ was added so that the elemental ratio of silicon was 1.0 mol (1.0 at %) to 100 mol of titanium. Other conditions were the same as in Example 1.

### Comparative Example 12

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MgO was added so that the elemental ratio of magnesium was 5.0 mol (5.0 at %) to 100 mol of titanium, and SiO₂ was added so that the elemental ratio of silicon was 1.0 mol (1.0 at %) to 100 mol of titanium. Other conditions were the same as in Example 1.

### Comparative Example 13

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 0.1 mol (0.1 at %) to 100 mol of titanium. Other conditions were the same as in Example 1.

### Example 13

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 0.5 mol (0.5 at %) to 100 mol of titanium. Other conditions were the same as in Example 1.

### Example 14

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 3.0 mol (3.0 at %) to 100 mol of titanium. Other conditions were the same as in Example 1.

### Comparative Example 14

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.5 mol (0.5 at %) to 100 mol of titanium, and SiO₂ was added so that the elemental ratio of silicon was 10.0 mol (10.0 at %) to 100 mol of titanium. Other conditions were the same as in Example 1.

### Example 15

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, V₂O₃ was added so that the elemental ratio of vanadium was 0.05 mol (0.05 at %) to 100 mol of titanium, MoO₃ was added so that the elemental ratio of molybdenum was 0.05 mol (0.05 at %) to 100 mol of titanium, MnCO₃ was added so that the elemental ratio of manganese was 0.5 mol (0.5 at %) to 100 mol of titanium, and SiO₂ was added so that the elemental ratio of silicon was 1.0 mol (1.0 at %) to 100 mol of titanium. Other conditions were the same as in Example 1.

### Example 16

TiO₂ was added to BaTiO₃ powder so that the Ba/Ti element ratio was 0.96. Dy₂O₃ was added so that the elemental ratio of dysprosium was 1.5 mol (1.5 at %) to 100 mol of titanium, MoO₃ was added so that the elemental ratio of molybdenum was 0.1 mol (0.1 at %) to 100 mol of titanium, MnCO₃ was added so that the elemental ratio of manganese was 0.1 mol (0.1 at %) to 100 mol of titanium, MgO was added so that the elemental ratio of magnesium was 0.05 mol (0.05 at %) to 100 mol of titanium, and SiO₂ was added so that the elemental ratio of silicon was 1.0 mol (1.0 at %) to 100 mol of titanium. Other conditions were the same as in Example 1.

The multilayer ceramic capacitor that had undergone the re-oxidation treatment was left standing in a constant temperature bath at 150° C. for 2 hours, and then taken out to room temperature. After 24 hours, the capacity and tan δ were measured using an LCR meter under the conditions of 1 kHz and 1 Vrms. Thereafter, the multilayer ceramic capacitor was placed in a chamber for measuring temperature characteristics, and the capacity and tan δ at each temperature were measured while increasing the temperature from −55° C. to 150° C. A multilayer ceramic capacitor in which grain growth has significantly progressed exhibits a large value of tan δ exceeding 20%. In this test, those in which such an abnormality in tan δ was observed were judged to be defective due to short circuits. This is because a short-circuited multilayer ceramic capacitor cannot be used as an electronic component.

The DC resistivity ρ (Ω·cm) was calculated according to ρ=(V/I)×(S/t), where the DC voltage at the time of measurement was V (V). “S” is the cross-sectional area, and “t” is the distance between the electrodes. Regarding DC current I, the multilayer ceramic capacitor was kept in a thermostatic oven at 125° C. for 30 minutes, insulation from the surroundings was ensured using a ceramic insulator, and the electric wire was connected from the thermostatic oven to the external electrode. The measurement electric field was 10 V/μm, that is, when the thickness of the dielectric layer was 2 μm, 20 V was applied for 30 seconds, the DC current I was measured, and the DC resistivity p was calculated.

In order to investigate the reliability of the fabricated multilayer ceramic capacitor, a Highly Accelerated Life Test (HALT) was conducted. HALT was performed at 125° C. and 50 V/μm.

In addition, the dielectric constant (hereinafter referred to as effective dielectric constant) of the multilayer ceramic capacitor at high temperature and under application of Dc Bias was measured. The multilayer ceramic capacitor was placed in a constant temperature bath, the temperature of the constant temperature bath was raised to 80° C., Dc Bias was applied at 2 V/μm, and the dielectric constant was measured.

The results are shown in Table 1.

TABLE 1

| | | | | | | | | | | HALT | |
|---|---|---|---|---|---|---|---|---|---|---|---|
| | | Dy/Ti | V/Ti | Mo/Ti | Mn/Ti | Mg/Ti | Si/Ti | tan δ | RELATIVE | LIFE | RESISTIVITY |
| | Ba/Ti | (at %) | (at %) | (at %) | (at %) | (at %) | (at %) | (%) | DIELECTRIC | TIME | (Ωm) |
| COMPARATIVE EXAMPLE 1 | 1.00 | 1.5 | 0 | 0.1 | 0.5 | 0 | 1.0 | 24 | SHORT | — | — |
| EXAMPLE 1 | 0.98 | 1.5 | 0 | 0.1 | 0.5 | 0 | 1.0 | 11 | 2154 | 6020 | 1.27 × 10⁷ |
| EXAMPLE 2 | 0.90 | 1.5 | 0 | 0.1 | 0.5 | 0 | 1.0 | 8.5 | 2020 | 7020 | 1.15 × 10⁷ |
| COMPARATIVE EXAMPLE 2 | 0.80 | 1.5 | 0 | 0.1 | 0.5 | 0 | 1.0 | 7 | 1900 | 6080 | 1.25 × 10⁵ |
| COMPARATIVE EXAMPLE 3 | 0.96 | 0 | 0 | 0.1 | 0.5 | 0 | 1.0 | 50 | SHORT | — | — |
| EXAMPLE 3 | 0.96 | 0.5 | 0 | 0.1 | 0.5 | 0 | 1.0 | 10 | 2124 | 6050 | 2.25 × 10⁷ |
| EXAMPLE 4 | 0.96 | 1.0 | 0 | 0.1 | 0.5 | 0 | 1.0 | 11 | 2154 | 8050 | 1.25 × 10⁷ |
| COMPARATIVE EXAMPLE 4 | 0.96 | 5.0 | 0 | 0.1 | 0.5 | 0 | 1.0 | 12 | 1620 | 9050 | 1.25 × 10⁵ |
| COMPARATIVE EXAMPLE 5 | 0.96 | 1.5 | 0.01 | 0 | 0.5 | 0 | 1.0 | 10.1 | 1902 | 5 | 1.24 × 10⁷ |
| EXAMPLE 5 | 0.96 | 1.5 | 0.1 | 0 | 0.5 | 0 | 1.0 | 10.2 | 2105 | 4010 | 1.21 × 10⁷ |
| EXAMPLE 6 | 0.96 | 1.5 | 0.3 | 0 | 0.5 | 0 | 1.0 | 10.3 | 2102 | 5520 | 8.60 × 10⁵ |
| COMPARATIVE EXAMPLE 6 | 0.96 | 1.5 | 1.5 | 0 | 0.5 | 0 | 1.0 | 11.1 | SHORT | — | 1.25 × 10⁴ |
| COMPARATIVE EXAMPLE 7 | 0.96 | 1.5 | 0 | 0.01 | 0.5 | 0 | 1.0 | 10 | 1900 | 5 | 1.25 × 10⁷ |
| EXAMPLE 7 | 0.96 | 1.5 | 0 | 0.1 | 0.5 | 0 | 1.0 | 10.1 | 2154 | 4020 | 1.22 × 10⁷ |
| EXAMPLE 8 | 0.96 | 1.5 | 0 | 0.3 | 0.5 | 0 | 1.0 | 10.2 | 2114 | 5420 | 8.50 × 10⁵ |
| COMPARATIVE EXAMPLE 8 | 0.96 | 1.5 | 0 | 1.5 | 0.5 | 0 | 1.0 | 11 | SHORT | — | 1.25 × 10⁴ |
| COMPARATIVE EXAMPLE 9 | 0.96 | 1.5 | 0 | 0.1 | 0.01 | 0 | 1.0 | 45 | SHORT | — | — |
| EXAMPLE9 | 0.96 | 1.5 | 0 | 0.1 | 0.15 | 0 | 1.0 | 8 | 2124 | 6050 | 1.10 × 10⁶ |
| EXAMPLE 10 | 0.96 | 1.5 | 0 | 0.1 | 2.0 | 0 | 1.0 | 6 | 2050 | 7020 | 1.25 × 10⁷ |
| COMPARATIVE EXAMPLE 10 | 0.96 | 1.5 | 0 | 0.1 | 5.0 | 0 | 1.0 | 5 | 1800 | 5050 | 1.21 × 10⁷ |
| COMPARATIVE EXAMPLE 11 | 0.96 | 1.5 | 0 | 0.1 | 0 | 0.01 | 1.0 | 47 | SHORT | — | — |
| EXAMPLE 11 | 0.96 | 1.5 | 0 | 0.1 | 0 | 0.1 | 1.0 | 8 | 2114 | 6050 | 1.15 × 10⁷ |
| EXAMPLE 12 | 0.96 | 1.5 | 0 | 0.1 | 0 | 2.0 | 1.0 | 6 | 2050 | 7020 | 1.25 × 10⁷ |
| COMPARATIVE EXAMPLE 12 | 0.96 | 1.5 | 0 | 0.1 | 0 | 5.0 | 1.0 | 7 | 1700 | 2050 | 1.25 × 10⁸ |
| COMPARATIVE EXAMPLE13 | 0.96 | 1.5 | 0 | 0.1 | 0.5 | 0 | 0.1 | 50 | 2190 | 60 | 1.20 × 10⁸ |
| EXAMPLE 13 | 0.96 | 1.5 | 0 | 0.1 | 0.5 | 0 | 0.5 | 10 | 2154 | 6050 | 1.25 × 10⁷ |
| EXAMPLE 14 | 0.96 | 1.5 | 0 | 0.1 | 0.5 | 0 | 3.0 | 10 | 2114 | 7030 | 5.25 × 10⁷ |
| COMPARATIVE EXAMPLE 14 | 0.96 | 1.5 | 0 | 0.1 | 0.5 | 0 | 10.0 | 10 | 1700 | 8030 | 8.25 × 10⁷ |
| EXAMPLE 15 | 0.96 | 1.5 | 0.05 | 0.05 | 0.5 | 0 | 1.0 | 10.1 | 2150 | 4025 | 1.23 × 10⁷ |
| EXAMPLE 16 | 0.96 | 1.5 | 0 | 0.1 | 0.1 | 0.05 | 1.0 | 8 | 2120 | 6055 | 1.10 × 10⁶ |

In Comparative Examples 1 and 2 and Examples 1 and 2, the Ba/Ti element ratio was changed. In Comparative Example 1 in which the Ba/Ti element ratio was 1.0, the tan δ after firing was a significantly high value. A multilayer ceramic capacitor exhibiting a high tan δ cannot be used as an electronic component and has extremely poor insulation properties, making it impossible to accurately evaluate capacity and insulation properties. Therefore, electrical property evaluation was not performed on the sample of Comparative Example 1.

On the other hand, the samples of Examples 1 and 2 and Comparative Example 2 showed values of tan δ of about 7% to 11%, so it was possible to measure capacity and insulation. In addition, the samples of Examples 1 and 2 had resistivities ranging from 1.15×10⁷ to 1.27×10⁷ Ω·m. This is considered to be because in Examples 1 and 2, the Ba/Ti element ratio was set to 0.90 or more and 0.98 or less. The sample of Comparative Example 2 showed a significantly low resistivity of 1.25×10⁵ Ω·m. This is considered to be because the Ba/Ti element ratio was set to 0.80. It is known that titanium can have trivalent and tetravalent valences, and electrons are generated when the valence changes from Ti³⁺ to Ti⁴⁺+e⁻. In Comparative Example 2, it is considered that the insulation properties deteriorated in this way. The results of Examples 1 and 2 and Comparative Examples 1 and 2 showed that the Ba/Ti element ratio was preferably 0.90 or more and 0.98 or less.

In Comparative Examples 3 and 4 and Examples 3 and 4, the Dy/Ti element ratio was changed. The sample of Comparative Example 3 showed an abnormally high value of tan δ=50%. This is thought to be due to the fact that in Comparative Example 3, the amount of dysprosium added was 0 mol (0 at %) per 100 mol of titanium, so the amount of dysprosium added was too small and the barium titanate was reduced. On the other hand, the samples of Examples 3 and 4 showed normal tan δ and had high insulation properties. This is considered to be because in Examples 3 and 4, the amounts of dysprosium added to 100 mol of titanium were 0.5 mol (0.5 at %) and 1.0 mol (1.0 at %). The sample of Comparative Example 4 had worse insulation properties than Examples 3 and 4. This is considered to be because in Comparative Example 4, the amount of dysprosium added was 5 mol (5 at %) with respect to 100 mol of titanium, so dysprosium substituted as a solid solution at the A site of barium titanate and acted as a donor.

In Comparative Examples 5 and 6 and Examples 5 and 6, the V/Ti element ratio was changed. The sample of Comparative Example 5 exhibited a significantly short HALT lifetime of 5 minutes. This is because in Comparative Example 5, the amount of vanadium added was 0.01 mol (0.01 at %) per 100 mol of titanium, so the amount of vanadium added was too small and the oxide ion vacancy concentration became high. On the other hand, the samples of Examples 5 and 6 showed a long HALT life of 4000 minutes or more. This is considered to be because in Examples 5 and 6, the amount of vanadium added was 0.1 mol (0.1 at %) and 0.3 mol (0.3 at %) with respect to 100 mol of titanium, respectively. The sample of Comparative Example 6 had worse insulation properties than Examples 5 and 6. This is considered to be due to the fact that in Comparative Example 6, the amount of vanadium added was 1.5 mol (1.5 at %) with respect to 100 mol of titanium, so that vanadium acted as a donor.

In Comparative Examples 7 and 8 and Examples 7 and 8, the Mo/Ti element ratio was changed. The sample of Comparative Example 7 exhibited a significantly short HALT lifetime of 5 minutes. This is because in Comparative Example 7, the amount of molybdenum added was 0.01 mol (0.01 at %) per 100 mol of titanium, so the amount of molybdenum added was too small and the oxide ion vacancy concentration became high. On the other hand, the samples of Examples 7 and 8 showed a long HALT life of 4000 minutes or more. This is considered to be because in Examples 7 and 8, the amount of molybdenum added was 0.1 mol (0.1 at %) and 0.3 mol (0.3 at %) with respect to 100 mol of titanium, respectively. The sample of Comparative Example 8 had worse insulation properties than Examples 7 and 8. This is considered to be due to the fact that in Comparative Example 8, the amount of molybdenum added was 1.5 mol (1.5 at %) with respect to 100 mol of titanium, so that molybdenum acted as a donor.

In Comparative Examples 9 and 10 and Examples 9 and 10, the Mn/Ti element ratio was changed. The sample of Comparative Example 9 showed an abnormally high value of tan δ=45%. This is because in Comparative Example 9, the amount of molybdenum added was 0.01 mol (0.01 at %) per 100 mol of titanium, so the amount of manganese added was too small and the barium titanate was reduced. On the other hand, the samples of Examples 9 and 10 showed normal tan δ. This is considered to be because in Examples 9 and 10, the amount of manganese added was 0.15 mol (0.15 at %) and 2.0 mol (2.0 at %) with respect to 100 mol of titanium, respectively. The effective dielectric constant of the sample of Comparative Example 10 was 1800, which was a low value. This is because in Comparative Example 10, the amount of manganese added was 5.0 mol (5.0 at %) per 100 mol of titanium, so the amount of manganese added was too large and grain growth was suppressed, and furthermore, manganese acted as an acceptor, resulting in increase in the oxide ion vacancy concentration.

In Comparative Examples 11 and 12 and Examples 11 and 12, the Mg/Ti element ratio was changed. The sample of Comparative Example 11 showed an abnormally high value of tan δ=47%. This is because in Comparative Example 11, the amount of magnesium added was 0.01 mol (0.01 at %) per 100 mol of titanium, so the amount of magnesium added was too small and the barium titanate was reduced. On the other hand, the samples of Examples 11 and 12 showed normal tan δ. This is considered to be because in Examples 11 and 12, the amount of magnesium added was 0.1 mol (0.1 at %) and 2.0 mol (2.0 at %) with respect to 100 mol of titanium, respectively. The effective dielectric constant of the sample of Comparative Example 12 was 1700, which was a low value. This is because in Comparative Example 12, the amount of magnesium added was 5.0 mol (5.0 at %) per 100 mol of titanium, so the amount of magnesium added was too large and grain growth was suppressed, and furthermore, magnesium was used as an acceptor, and the concentration of the oxide ion vacancy concentration increases, resulting in pinning of the domain movement.

In Comparative Examples 13 and 14 and Examples 13 and 14, the Si/Ti element ratio was changed. The sample of Comparative Example 13 exhibited a significantly shorter HALT lifetime of 60 minutes. This is because in Comparative Example 13, the amount of silicon added was 0.1 mol (0.1 at %) with respect to 100 mol of titanium, so a phase containing silicon was not formed at the grain boundaries, and oxide ion vacancies easily moved at the grain boundaries. On the other hand, in the samples of Examples 13 and 14, sufficiently dense samples were obtained, and the effective dielectric constant and reliability were also good values. This is considered to be because in Examples 13 and 4, the amount of silicon added was 0.5 mol (0.5 at %) and 3.0 mol (3.0 at %) with respect to 100 mol of titanium, respectively. The sample of Comparative Example 14 had a low effective dielectric constant of 1700. This is because in Comparative Example 14, the amount of silicon added was 10.0 mol (10.0 at %) per 100 mol of titanium, so the amount of silicon added was too large, and the volume percentage of the secondary phase with a low dielectric constant containing silicon increased.

Example 15 is a modification of Examples 5 to 8, in which both vanadium and molybdenum were added. The sample of Example 15 exhibited a long HALT life of over 4000 minutes. This is considered to be because in Example 15, the amount of vanadium added was 0.05 mol (0.05 at %) and the amount of molybdenum added was 0.05 mol (0.05 at %) with respect to 100 mol of titanium. Thus, good results were obtained even when both vanadium and molybdenum were added.

Example 16 is a modification of Examples 9 to 12, and both manganese and magnesium were added. The sample of Example 16 exhibited a long HALT life of over 4000 minutes. This is considered to be because in Example 16, the amount of manganese added was 0.1 mol (0.1 at %) and the amount of magnesium added was 0.05 mol (0.05 at %) with respect to 100 mol of titanium. In Example 16, as described above, good results were obtained even when both manganese and magnesium were added.

Table 2 shows the presence or absence of core-shell and the presence or absence of Ba₄Ti₁₁O₂₆. In Comparative Example 1, first crystal grains having a core-shell structure containing dysprosium in the shell portion were confirmed, but Ba₄Ti₁₁O₂₆, which is a second crystal grain with an elemental ratio of barium to titanium of 0.70 or less, was not confirmed. This is considered to be because the Ba/Ti element ratio was 1.0. On the other hand, in Examples 1 and 2, first crystal grains having a core-shell structure containing dysprosium in the shell portion were confirmed, and Ba₄Ti₁₁O₂₆ which was second crystal grains having an elemental ratio of barium to titanium of 0.70 or less was confirmed. This is considered to be because the Ba/Ti element ratio was set to 0.90 or more and 0.98 or less.

Furthermore, in Comparative Example 3, a core-shell structure containing dysprosium in the shell portion was not confirmed. This is considered to be because dysprosium was not added in Comparative Example 3. On the other hand, in Examples 3 and 4, a core-shell structure was confirmed in which the concentration of dysprosium in the shell portion was higher than the concentration of dysprosium in the core portion. This is considered to be because in Examples 3 and 4, the amount of dysprosium added to 100 mol of titanium was 0.5 mol (0.5 at %) and 1.0 mol (1.0 at %), respectively.

TABLE 2

| | | | | Dy CONCENTRATION | | | SECOND |
|---|---|---|---|---|---|---|---|
| | | | | (at %) | | | CRYSTAL |
| | | Dy | CORE | SHELL | CORE | | GRAIN |
| | Ba/Ti | (at %) | SHELL | PORTION | PORTION | Ba₄Ti₁₁O₂₆ | Ba/Ti |
| COMPARATIVE EXAMPLE 1 | 1.00 | 1.5 | PRESENCE | 3.1 | 0 | ABSENCE | — |
| EXAMPLE 1 | 0.98 | 1.5 | PRESENCE | 2.9 | 0 | PRESENCE | 0.43 |
| EXAMPLE 2 | 0.90 | 1.5 | PRESENCE | 2.4 | 0 | PRESENCE | 0.29 |
| COMPARATIVE EXAMPLE 2 | 0.80 | 1.5 | PRESENCE | 2.3 | 0 | PRESENCE | 0.2 |
| COMPARATIVE EXAMPLE 3 | 0.96 | 0 | ABSENCE | — | 2 | PRESENCE | 0.39 |
| EXAMPLE 3 | 0.96 | 0.5 | PRESENCE | 1.1 | 0 | PRESENCE | 0.39 |
| EXAMPLE 4 | 0.96 | 1.0 | PRESENCE | 2.3 | 0 | PRESENCE | 0.39 |

Although the embodiments of the present invention have been described in detail, it is to be understood that the various change, substitutions, and alterations could be made hereto without departing from the spirit and scope of the invention.

What is claimed is:

1. A dielectric ceramic composition comprising:
a first crystal grain that has a perovskite structure expressed by a general formula of BaTiO₃, and has a core portion and a shell portion surrounding the core portion and including dysprosium; and
a second crystal grain in which an elemental ratio of barium to titanium is 0.70 or less and a main component is barium titanate composite oxide,
wherein an elemental ratio of barium to titanium of the dielectric ceramic composition is 0.90 or more and 0.98 or less.

2. The dielectric ceramic composition as claimed in claim 1,
wherein the first crystal grain includes a donor element; and
wherein a concentration of the donor element at a grain boundary or a grain boundary triple point of the first crystal grain is larger than that in the first crystal grain.

3. The dielectric ceramic composition as claimed in claim 2,
wherein the donor element is at least one of vanadium and molybdenum.

4. The dielectric ceramic composition as claimed in claim 1,
wherein the second crystal grain is at least one selected from a group of BaTi₂O₅, BaTi₄O₉, BaTi₅O₁₁, BaTi₆O₁₃, Ba₄Ti₁₁O₂₆, Ba₄Ti₁₂O₂₇, BaTi₁₃O₃₀, Ba₄Ti₁₄O₂₇, or Ba₆Ti₁₇O₄₀.

5. The dielectric ceramic composition as claimed in claim 1,
wherein, in the first crystal grain, a concentration of dysprosium of the shell portion is higher than that of the core portion.

6. The dielectric ceramic composition as claimed in claim 2, wherein the first crystal grain includes an acceptor element.

7. The dielectric ceramic composition as claimed in claim 6, wherein the acceptor element is at least one of manganese or magnesium.

8. A dielectric ceramic composition comprising:
barium titanate as a main component,
wherein an elemental ratio of barium to titanium is 0.90 or more and 0.98 or less, and
wherein the dielectric ceramic composition contains 0.5 mol or more and 3.0 mol or less of dysprosium per 100 mol of titanium, contains 0.05 mol or more and 0.5 mol or less of a donor element per 100 mol of titanium, contains 0.05 mol or more and 3.0 mol or less of an acceptor element per 100 mol of titanium, and contains 0.5 mol or more and 3.0 mol or less of silicon per 100 mol of titanium.

9. The dielectric ceramic composition as claimed in claim 8, wherein the donor element is at least one of vanadium or molybdenum.

10. The dielectric ceramic composition as claimed in claim 8, wherein the acceptor element is at least one of manganese or magnesium.

11. A multilayer ceramic electronic device comprising:
a dielectric ceramic composition as claimed in claim 1.
